(19) United States
(12) Patent Application Publication
(10) Pub. No.: US 2006/0010277 A1
(43) Pub. Date: Jan. 12, 2006

(54) Isolation of input/output adapter interrupt domains

(75) Inventors: Richard Louis Arndt, Austin, TX (US); Patrick Allen Buckland, Austin, TX (US); Gregory Michael Nordstrom, Pine Island, MN (US); Steven Mark Thurber, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/887,525

(22) Filed: Jul. 8, 2004

(51) Int. Cl. G06F 13/24; G06F 13/14

(52) U.S. Cl. 710/305; 710/260; 710/262

(57) ABSTRACT

Method, apparatus and system for isolating input/output adapter interrupt domains in a data processing system. The data processing system includes a plurality of input/output adapters, and isolation of interrupt resources available to the input/output adapters is controlled by functionality in a host bridge that connects the plurality of input/output adapters to a system bus of the data processing system, thus permitting the use of low cost, industry standard switches and bridges external to the host bridge.

### CROSS REFERENCE TO RELATED APPLICATIONS

The present application is related to co-pending applications entitled “ISOLATION OF INPUT/OUTPUT ADAPTER DIRECT MEMORY ACCESS ADDRESSING DOMAINS”, Ser. No. ______, attorney docket no. AUS920040093US1; and “ISOLATION OF INPUT/OUTPUT ADAPTER ERROR DOMAINS”, Ser. No. ______, attorney docket no. AUS920040094US1, all filed on even date herewith. All the above related applications are assigned to the same assignee and are incorporated herein by reference.

### BACKGROUND OF THE INVENTION

1. Technical Field

The present invention relates generally to the data processing field and, more particularly, to a method, apparatus and system for isolating input/output adapter interrupt domains in a data processing system.

2. Description of Related Art

In a server environment, it is important to be able to isolate input/output adapters (IOAs) so that an IOA can only obtain access to the resources which are allocated to it. Isolating IOAs from one another is important to create a system that is robust from a reliability and availability standpoint, and is especially important in a logical partitioned (LPAR) data processing system, so that IOAs, or parts of IOAs, can be allocated on an individual basis to different LPAR partitions.

In particular, in an LPAR data processing system, multiple operating systems or multiple copies of a single operating system are run on a single data processing system platform. Each operating system or operating system copy executing within the data processing system is assigned to a different logical partition, and each partition is allocated a non-overlapping subset of the resources of the platform. Thus, each operating system or operating system copy directly controls a distinct set of allocatable resources within the platform.

In a data processing system, it is important that IOAs, or parts of IOAs, not be able to gain access to the interrupt resources of other IOAs or other parts of IOAs. Isolation of IOA interrupt resources is important, for example, to prevent a demand of service attack by one IOA that can result in an overall system breakdown. In an LPAR data processing system environment, in particular, it is important that interrupt resources not be shared between IOAs because doing so will restrict the ability to assign the IOAs, or parts of IOAs, to different partitions of the system.

Currently, isolation of the interrupt resources of IOAs is accomplished by using unique, specially designed bridge chips that are located externally of the PCI (Peripheral Component Interconnect) Host Bridge (PHB). Such unique bridge chips are relatively expensive and preclude the use of less costly, industry standard bridges in the data processing system.

It would, accordingly, be advantageous to provide for isolation of the interrupt resources available to an IOA in a data processing system without requiring the use of expensive, unique bridge chips.

### SUMMARY OF THE INVENTION

The present invention provides a method, apparatus and system for isolating input/output adapter interrupt domains in a data processing system. The data processing system includes a plurality of input/output adapters, and isolation of interrupt resources available to the input/output adapters is controlled by functionality in a host bridge that connects the plurality of input/output adapters to a system bus of the data processing system, thus permitting the use of low cost, industry standard switches and bridges external to the host bridge.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which the present invention may be implemented;

FIG. 2 is a block diagram of an exemplary logical partitioned platform in which the present invention may be implemented;

FIG. 3 is a block diagram that illustrates a known system for providing resource isolation in a data processing system to assist in explaining the present invention;

FIG. 4 is a block diagram that illustrates a system for providing resource isolation in a data processing system in accordance with a preferred embodiment of the present invention;

FIG. 5 is a conceptual flow diagram that illustrates an operation for isolating input/output adapter interrupt domains in a data processing system in accordance with a preferred embodiment of the present invention; and

FIGS. 6A and 6B are portions of a flowchart that illustrates a method for isolating input/output adapter interrupt domains in a data processing system in accordance with a preferred embodiment of the present invention.

### DETAILED DESCRIPTION OF THE PREFERRED EMBODIMENT

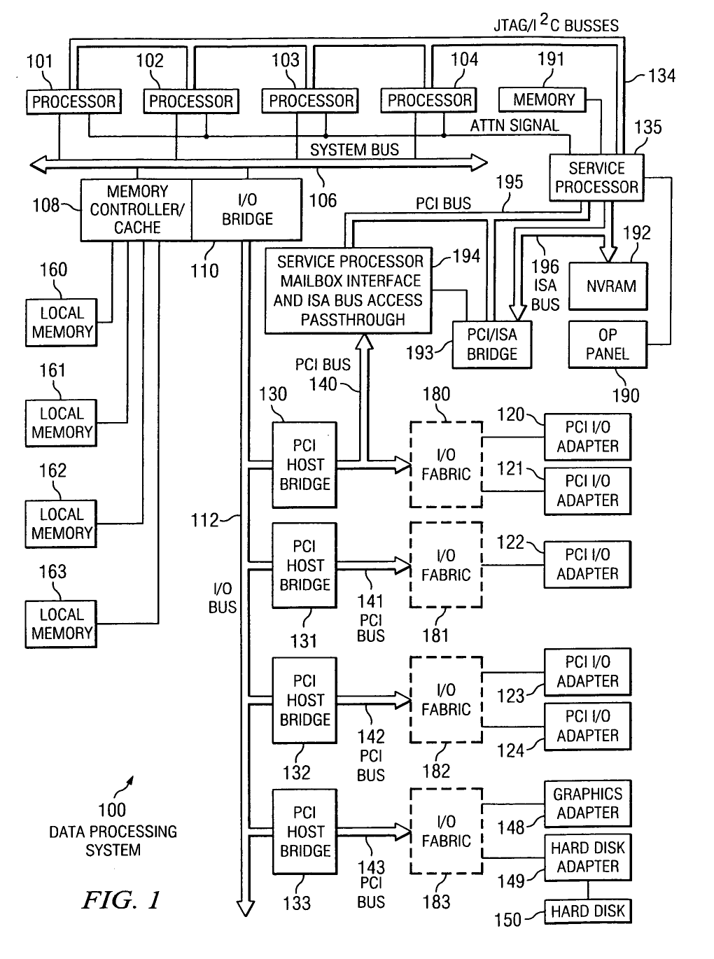

With reference now to the figures, FIG. 1, depicts a block diagram of a data processing system in which the present invention may be implemented. Data processing system 100 may be a symmetric multiprocessor (SMP) system including a plurality of processors 101, 102, 103, and 104 connected to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 is connected to system bus 106 and provides an interface to I/O bus 112. Memory controller/cache 108 and I/O bus bridge 110 may be integrated as depicted.

Data processing system 100 is a logical partitioned (LPAR) data processing system, however, it should be understood that the invention is not limited to an LPAR system but can also be implemented in other data processing systems. LPAR data processing system 100 has multiple heterogeneous operating systems (or multiple copies of a single operating system) running simultaneously. Each of these multiple operating systems may have any number of software programs executing within it. Data processing system 100 is logically partitioned such that different PCI input/output adapters (IOAs) 120, 121, 122, 123 and 124, graphics adapter 148 and hard disk adapter 149, or parts thereof, may be assigned to different logical partitions. In this case, graphics adapter 148 provides a connection for a display device (not shown), while hard disk adapter 149 provides a connection to control hard disk 150.

Thus, for example, suppose data processing system 100 is divided into three logical partitions, P1, P2, and P3. Each of PCI IOAs 120-124, graphics adapter 148, hard disk adapter 149, each of host processors 101-104, and memory from local memories 160-163 is assigned to each of the three partitions. In this example, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and PCI IOAs 121, 123 and 124 may be assigned to logical partition P1; processors 102-103, some portion of memory from local memories 160-163, and PCI IOAs 120 and 122 may be assigned to partition P2; and processor 104, some portion of memory from local memories 160-163, graphics adapter 148 and hard disk adapter 149 may be assigned to logical partition P3.

Each operating system executing within a logically partitioned data processing system 100 is assigned to a different logical partition. Thus, each operating system executing within data processing system 100 may access only those IOAs that are within its logical partition. For example, one instance of the Advanced Interactive Executive (AIX) operating system may be executing within partition P1, a second instance (copy) of the AIX operating system may be executing within partition P2, and a Linux or OS/400 operating system may be operating within logical partition P3.

Peripheral component interconnect (PCI) host bridges (PHBs) 130, 131, 132 and 133 are connected to I/O bus 112 and provide interfaces to PCI local busses 140, 141, 142 and 143, respectively. PCI IOAs 120-121 are connected to PCI local bus 140 through I/O fabric 180, which comprises switches and bridges. In a similar manner, PCI IOA 122 is connected to PCI local bus 141 through I/O fabric 181, PCI IOAs 123 and 124 are connected to PCI local bus 142 through I/O fabric 182, and graphics adapter 148 and hard disk adapter 149 are connected to PCI local bus 143 through I/O fabric 183. The I/O fabrics 180-183 provide interfaces to PCI busses 140-143 and will be described in greater detail hereinafter. A typical PCI host bridge will support between four and eight IOAs (for example, expansion slots for add-in connectors). Each PCI IOA 120-124 provides an interface between data processing system 100 and input/output devices such as, for example, other network computers, which are clients to data processing system 100.

PCI host bridge 130 provides an interface for PCI bus 140 to connect to I/O bus 112. This PCI bus also connects PCI host bridge 130 to service processor mailbox interface and ISA bus access pass-through logic 194 and I/O fabric 180. Service processor mailbox interface and ISA bus access pass-through logic 194 forwards PCI accesses destined to the PCI/ISA bridge 193. NVRAM storage 192 is connected to the ISA bus 196. Service processor 135 is coupled to service processor mailbox interface and ISA bus access pass-through logic 194 through its local PCI bus 195. Service processor 135 is also connected to processors 101-104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 are connected together to an interrupt input signal of the service processor. The service processor 135 has its own local memory 191, and has access to the hardware OP-panel 190.

When data processing system 100 is initially powered up, service processor 135 uses the JTAG/I²C busses 134 to interrogate the system (host) processors 101-104, memory controller/cache 108, and I/O bridge 110. At completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 is responsible for saving and reporting error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using an IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

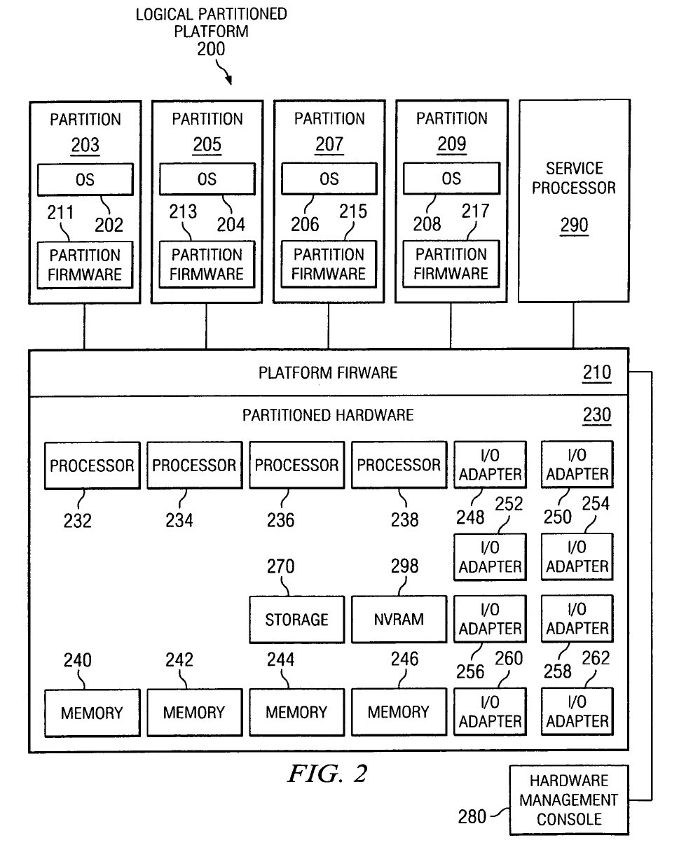

With reference now to FIG. 2, a block diagram of an exemplary logical partitioned platform is depicted in which the present invention may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor. OS/400 is used only as an example in these illustrative embodiments. Other types of operating systems, such as AIX and Linux, may also be used depending on the particular implementation. Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232-238, a plurality of system memory units 240-246, a plurality of IOAs 248-262, and a storage unit 270. Each of the processors 232-238, memory units 240-246, NVRAM storage 298, and IOAs 248-262, or parts thereof, may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

In an LPAR environment, it is not permissible for resources or programs in one partition to affect operations in another partition. Furthermore, to be useful, the assignment of resources needs to be fine-grained. For example, it is often not acceptable to assign all IOAs under a particular PHB to the same partition, as that will restrict configurability of the system, including the ability to dynamically move resources between partitions.

Accordingly, some functionality is needed in the bridges that connect IOAs to the I/O bus so as to be able to assign resources, such as individual IOAs or parts of IOAs to separate partitions; and, at the same time, prevent the assigned resources from affecting other partitions such as by obtaining access to resources of the other partitions.

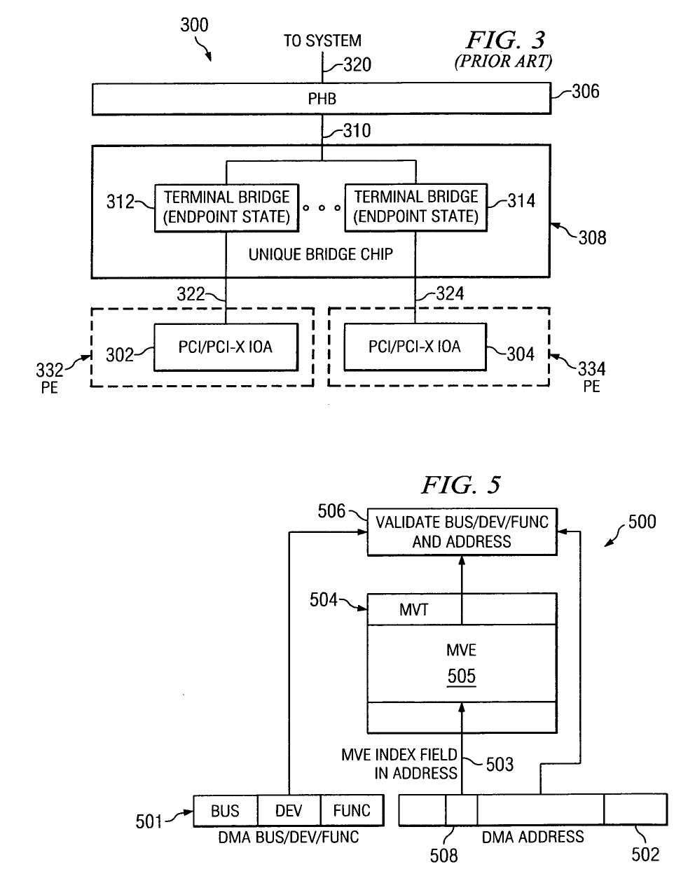

FIG. 3 is a block diagram that illustrates a known system for providing resource isolation in a data processing system to assist in explaining the present invention. The system is generally designated by reference number 300, and includes a plurality of IOAs, for example, IOAs 302 and 304. IOAs 302 and 304 are connected to PHB 306 of a data processing system, such as data processing system 100 illustrated in FIG. 1, through a bridge structure that comprises unique, specially designed bridge chip 308. Bridge chip 308 is connected to PHB 306 by PCI local bus 310, and PHB 306 is, in turn, ultimately connected to a system bus, such as system bus 106 in FIG. 1, possibly as through I/O bus 112 and I/O bridge 110 in FIG. 1, and to other components of the data processing system as represented at 320.

Unique bridge chip 308 includes a terminal bridge for each IOA. In particular, IOA 302 is connected to terminal bridge 312 by PCI bus 322, and IOA 304 is connected to terminal bridge 314 by PCI bus 324. Terminal bridges 312 and 314 contain endpoint states of IOAs 302 and 304, respectively, and serve to isolate IOAs 302 and 304 from one another.

In resource isolation system 300 illustrated in FIG. 3, IOAs 302 and 304 comprise input/output units that are capable of being isolated from one another in unique bridge chip 308; and, therefore, can, for example, be assigned to different partitions of an LPAR data processing system. An input/output unit, or portion thereof, that can be isolated from other input/output units of a data processing system and that can be separately assigned to different partitions of an LPAR data processing system is referred to herein as a “Partitionable Endpoint” or a “PE”. A PE, as used herein, is defined as being any part of an I/O subsystem that can be assigned to a partition independent of any other part of the I/O subsystem. Thus, in resource isolation system 300 in FIG. 3, each IOA 302 and 304 can also be considered as PEs 332 and 334, respectively.

As will become apparent hereinafter, a PE as defined herein also comprises an input/output unit that is something more or something less than a single IOA. For example, a PE also comprises a plurality of IOAs that function together and, thus, that should be assigned as a unit to a single partition. A PE can also comprise a portion of a single IOA, for example, two ports of a chip that perform as separately configurable functions. If the two ports provide separate functions, they are capable of being separately assigned to different partitions; and, thus, each port may be defined as a separate PE. In general, a PE is defined by its function rather than by its structure.

The present invention utilizes the concept of a PE to provide a resource isolation system in which the isolation functionality is moved from a unique bridge chip located externally of the PHB, such as in system 300 in FIG. 3, to the PHB itself.

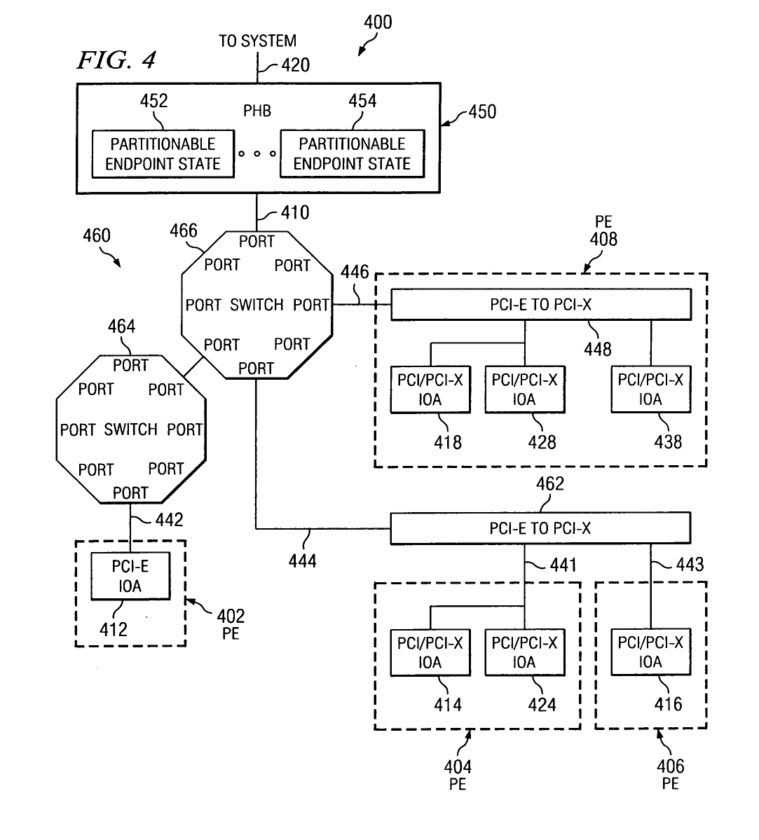

In particular, FIG. 4 is a block diagram that illustrates a system for providing resource isolation in a data processing system in accordance with a preferred embodiment of the present invention. The system is generally designated by reference number 400, and comprises a plurality of PEs 402, 404, 406 and 408 that are capable of being assigned to different partitions of an LPAR data processing system. PEs 402, 404, 406 and 408 are each connected to PHB 450 by an I/O fabric that is generally designated by reference number 460.

I/O fabric 460 includes PCI bridge 462 and switches 464 and 466, and is connected to PHB 450 by local PCI bus 410 that connects switch 466 to PHB 450, and to PEs 402, 404, 406 and 408 by various secondary busses. As shown in FIG. 4, PCI busses 410, 442, 444, and 446 are PCI-Express (PCI-E) links. In particular, as shown in FIG. 4, PE 402 is connected to PHB 450 by secondary bus 442, switches 464 and 466 and local bus 410. PE 404 is connected to PHB 450 by secondary bus 441, PCI bridge 462, secondary bus 444, switch 466, and local bus 410. PE 406 is connected to PHB 450 by secondary bus 443, PCI bridge 462, secondary bus 444, switch 466, and local bus 410. PE 408 is connected to PHB 450 by local bus 446, switch 466 and local bus 410.

It should be understood that the specific configuration of I/O fabric 460 illustrated in FIG. 4 is intended to be exemplary only. The I/O fabric can be assembled in any appropriate manner using any suitable arrangement of busses, bridges and switches. Also, it should be understood that one or more of PEs 402, 404, 406 and 408 can be connected directly to PHB 450 rather than being connected to PHB 450 through I/O fabric 460 as shown in FIG. 4.

PE 402 and PE 406 each comprises a single IOA 412 and 416, respectively, such that IOAs 412 and 416 can each be assigned to a different partition of the data processing system. PE 404 comprises two IOAs 414 and 424 that function together and, thus, must be assigned to the same partition. PE 408 comprises three IOAs 418, 428 and 438 and bridge 448 that function together and must be assigned to the same partition.

In isolation system 400, the endpoint states of each PE, referred to herein as Partitionable Endpoint states, are located in PHB 450 in the illustrated example rather than in a unique bridge chip as in system 300 illustrated in FIG. 3. As a result, in system 400, I/O fabric 460 can be assembled using inexpensive, industry standard switch and bridge chips, thus permitting a reduction in the overall cost of the data processing system while retaining all required isolation functions.

The ability to move the isolation functionality from a unique bridge chip to the PHB is achieved, in part, by providing a PE Domain Number that associates various domain components to the same PE. The PE Domain Number is an identifier that includes a plurality of fields that can be used to differentiate different IOAs in a PE. These fields include:
Bus number (Bus) field-the highest level of division. Each bus under a PHB has a unique bus number.
Device number (Dev) field within the Bus number-the next level of division. Each IOA on a bus has a different device number.
Function number (Func) field within the Device number-the lowest level of division. Each function of an IOA has a different function number (multiple function IOAs have multiple function numbers, and single function IOAs have one function number).

The PE Domain number (Bus/Dev/Func number), allows for division down to the lowest level of division i.e., use of all of the Bus/Dev/Func fields allows separate functions of a multiple function IOA to be differentiated. In isolation systems that do not require such a fine granularity, the PE Domain number can be defined by the Bus field alone, allowing differentiation between the PEs connected to the PHB, or by the Bus field together with either the Dev field or the Func field to permit differentiation between IOAs of a PE or differentiation between functions of an IOA in a PE that contains a multiple function IOA.

Among the isolation functionalities provided by PHB 450 in FIG. 4 include a functionality to isolate PE interrupt domains, in particular, a functionality for preventing one PE from gaining access to the interrupt resources of another PE. Isolation of PE interrupt resources is important, for example, to prevent a demand of service attack by one PE that can result in an overall system breakdown. In an LPAR data processing system environment, in particular, it is important that interrupt resources not be shared between PEs because doing so will restrict the ability to assign the PEs to different partitions of the system.

There are two types of interrupts that are supported for PEs in accordance with the present invention:

1. Level Signaled Interrupt(LSI)

In this type of interrupt, a PE activates an interrupt and does not deactivate the interrupt until instructed to do so by a device driver (DD). The DD must tell the PE to release the LSI prior to issuing an End of Interrupt (EOI) to an interrupt controller, and must do so in a way that guarantees that the request to release the LSI gets to the PE and gets signaled to the interrupt controller before the EOI gets to the interrupt controller, or else the interrupt controller will present the same interrupt again on receiving the EOI. The PE may try to activate the same interrupt signal for a different operation during the time it remains activated for a previous interrupt, and therefore, the interrupt processing must assure that all outstanding interrupts have been processed after telling the PE to release the interrupt.

2. Message Signaled Interrupt (MSI)

In this type of interrupt, a PE signals the interrupt by writing data containing interrupt information to a specific address that can be decoded by the system to be that of an interrupt controller. The interrupt is signaled once per occurrence and does not need to be released by the DD before an EOI is issued to the interrupt controller. An MSI is sometimes referred to as an “edge triggered” interrupt. As with an LSI, the PE may try to activate the same interrupt signal for a different operation prior to finishing processing of that same interrupt source for the previous operation. The timing requirements are somewhat different for an MSI, however, in that the DD must assure that after issuing an EOI to the interrupt controller, that the PE does not have any outstanding interrupts pending.

In general, the resource isolation system of the present invention includes mechanisms in the PHB that provide the following isolation functionalities:
1. a functionality to ensure that interrupts (both LSI and MSI) not be shared between PEs because doing so will limit the ability to assign PEs to different partitions;
2. a functionality to ensure that one PE is not able to signal an interrupt for another PE; and
3. a functionality to ensure that each interrupt have a separate XIVE (external Interrupt Vector table Entry).

The above functionalities are enabled by providing an MSI Validation Table (MVT) in the PHB. The MVT contains MSI Validation Entries (MVEs) that are used in conjunction with the PE Domain Number (Bus/Dev/Func number) of a PE requesting an interrupt operation to validate the PE's access to a range of MSIs.

In particular, FIG. 5 is a conceptual flow diagram that illustrates an operation for isolating input/output adapter interrupt domains in a data processing system in accordance with a preferred embodiment of the present invention. The operation is generally designated by reference number 500, and begins with DMA address 502 and the Bus/Dev/Func number 501 coming in on an I/O bus of the data processing system. The Bus/Dev/Func number uniquely identifies the entity that is requesting the operation.

The above isolation functionalities are enabled by providing an MSI Validation Table(MVT). The MVT is used in conjunction with the PE Domain Number (Bus/Dev/Func number) of a PE seeking access to a particular range of MSI interrupts. Different MSI ranges in the data processing system are associated with different PE Domain Numbers, and I/O bus access is controlled by using the MVT to match the PE domain Number of a PE requesting MSI access with the PE Domain Number associated with the I/O MSI range for which access is requested.

More particularly, the MVT in the PHB is a table of entries referred to as MSI Validation Entries (MVEs), each of which is assigned to a single PE. A specific MVE is selected by the address provided by the MSI operation, which comprises the PE Domain Number and the bus address. Those skilled in the art will recognize that there are several ways to get from this address provided by the PE to a unique entry in the MVT. For example, the PHB may use certain bits of the I/O bus address, MVE Index Bits 508 of DMA Address 502, as an index into MVT 503 to access a specific MVE 505 in MVT 504. Those skilled in the art will understand that the lookup in the MVT could also be performed by other methods such as by using the Bus/Dev/Func itself from the transaction, and creating a lookup based on a hash table and hashing algorithm. MVE 505 contains an 8-bit bus number field, and a 1-bit bus number validate field. Optionally, MVE 505 may also include a 5-bit device number field and a 1-bit device number validate field, and/or a 3-bit function number field and a 1-bit function number validate field. These fields are used to determine if the Bus/Dev/Func 501 coming in with the transaction has valid access to the MVE that it is trying to access as indicated at 506.

The MVE may also contain a valid bit, in which case this bit is also checked to see if the MVE itself is valid. If the PE Domain Number stored in the MVE does not match the corresponding field(s) in the incoming I/O bus transaction or if the MVE is not valid, the interrupt operation is not allowed to proceed and is aborted. If the interrupt operation is valid, it is allowed to proceed.

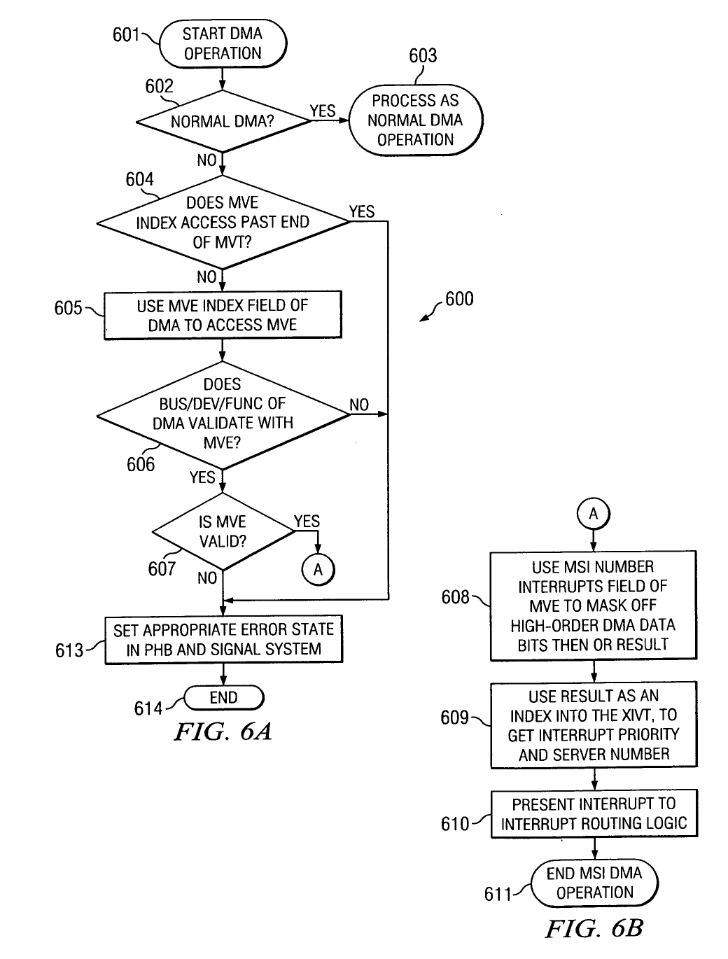

FIGS. 6A and 6B are portions of a flowchart that illustrates a method for isolating input/output adapter interrupt domains in a data processing system in accordance with a preferred embodiment of the present invention. The method is generally designated by reference number 600, and begins with the start of a DMA operation (step 601). A determination is then made if the DMA operation is a normal DMA operation or an MSI operation (step 602). This is accomplished, for example, by looking at particular bit in the DMA address. A zero-bit indicates a normal DMA, and a 1-bit indicates an MSI. If the DMA is a normal DMA operation (Yes output in step 602), the operation is processed as a normal DMA operation (step 603). If the DMA is an MSI operation (No output in step 602), a determination is made if the MVE Index Field from bits in the I/O address will access beyond the end of the MVT that is implemented (step 604), If Yes, error handling is performed (step 613), and the method ends (step 614). If No, the MVE Index field is used to access the MVE (step 605), and the Bus number and Bus number validate fields, and, optionally, the Device number and Device number validate fields and/or the Function number and Function number validate fields of the MVE are used to determine if the entity requesting the operation, as specified by the Bus/Dev/Func number of the entity, has access to the MVE (step 606). If the Bus/Dev/Func number does not validate (No output in step 606), error handling is performed (step 613) and the method ends (step 614). If the Bus/Dev/Func Number does validate (Yes output of step 606), the MVE is then checked to see if it is valid (step 607). The MVE validity is verified by checking an MVE valid bit in the MVE. If the MVE is not valid (No output of step 607) error handling is performed (step 613) and the method ends (step 614). If the MVE is valid (Yes output of step 607), an MSI Number Interrupts field of the MVE is used to mask off the appropriate number of high-order DMA data bits, i.e., to determine which data bits are valid; and the result is then ORed with an MSI Table Offset field of the MVE; i.e., the valid bits of the data are appended to the MSI Table Offset (step 608).

The result of step 608 is then used as the index into XIVT (external Interrupt Vector Table) to get the XIVE (step 609). The interrupt is then presented to interrupt routing logic, using the server number and priority from the XIVE (step 610); and the MSI DMA operation is complete (step 611).

The present invention thus provides a method, apparatus and system for isolating input/output adapter interrupt domains in a data processing system that includes a plurality of input/output adapters. Isolation of interrupt resources available to the input/output adapters is controlled by functionality in a host bridge that connects the plurality of input/output adapters to a system bus of the data processing system, thus permitting the use of low cost, industry standard switches and bridges external to the host bridge.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A data processing system, comprising:
a system bus;
a host bridge connected to the system bus; and
a plurality of input/output units connected to the host bridge, wherein the host bridge includes functionality for isolating interrupt resources available to the plurality of input/output units from one another.

2. The system according to claim 1, wherein each input/output unit is identified by an identifier, and wherein the host bridge includes functionality for isolating the interrupt resources available to the plurality of input/output units from one another using the identifier.

3. The system according to claim 2, wherein the identifier of each input/output unit includes at least a Bus number field that identifies its respective input/output unit.

4. The system according to claim 3, wherein the identifier of at least one of the plurality of input/output units further includes a Device number field that identifies an input/output adapter included in the at least one input/output unit.

5. The system according to claim 3, wherein the identifier of at least one of the plurality of input/output units further includes a Function number field that identifies a function of an input/output adapter included in the at least one input/output unit.

6. The system according to claim 2, wherein the host bridge includes a table having a plurality of entries, each of the plurality of entries capable of being assigned to a different input/output unit, and wherein the host bridge isolates interrupt resources available to the plurality of input/output units from one another using the identifier and the table.

7. The system according to claim 1, wherein the data processing system comprises a logical partitioned data processing system, and wherein each of the plurality of input/output units is capable of being assigned to a different logical partition of the logical partitioned data processing system.

8. The system according to claim 1, wherein each of the plurality of input/output units comprises one of an input/output adapter, a plurality of input/output adapters that function together and a portion of a multi-function input/output adapter.

9. The system according to claim 1, wherein at least one of the plurality of input/output units is connected to the host bridge through an input/output fabric.

10. A method for isolating interrupt resources available to a plurality of input/output units in a data processing system, comprising:
isolating the interrupt resources available to the plurality of input/output units from one another at a host bridge to which the plurality of input/output units are connected.

11. The method according to claim 10, wherein each of the plurality of input/output units has an identifier, and wherein the isolating includes isolating the interrupt resources available to the plurality of input/output units from one another using the identifier.

12. The method according to claim 11, wherein the host bridge includes a table having a plurality of entries, each of the plurality of entries capable of being assigned to a different input/output unit, and wherein the isolating includes isolating the interrupt resources available to the plurality of input/output units from one another using the identifier and the table.

13. The method according to claim 12, wherein the isolating includes comparing the identifier with a table entry to validate a request by an input/output unit for an interrupt operation.

14. The method according to claim 10, wherein the data processing system comprises a logical partitioned data processing system, and wherein each of the plurality of input/output units are capable of being assigned to a different logical partition of the logical partitioned data processing system.

15. An apparatus for isolating interrupt resources available to a plurality of input/output units in a data processing system, comprising:
a host bridge for connecting the plurality of input/output units to a system bus, the host bridge including functionality for isolating interrupt resources available to the plurality of input/output units from one another.

16. The apparatus according to claim 15, wherein each input/output unit includes an identifier, and wherein the host bridge includes functionality for isolating interrupt resources available to the plurality of input/output units from one another using the identifier.

17. The apparatus according to claim 16, wherein the host bridge includes a table having a plurality of entries, each of the plurality of entries capable of being assigned to a different input/output unit, and wherein the host bridge includes functionality for isolating interrupt resources available to the plurality of input/output units from one another using the identifier and the table.

18. The apparatus according to claim 17, wherein the functionality for isolating interrupt resources available to the plurality of input/output units from one another comprises functionality for comparing the identifier with a table entry to validate a request by an input/output unit for an interrupt operation.
